(19) United States
(12) Patent Application Publication
(10) Pub. No.: US 2010/0174544 A1
(43) Pub. Date: Jul. 8, 2010

(54) SYSTEM, METHOD AND END-USER DEVICE FOR VOCAL DELIVERY OF TEXTUAL DATA

(76) Inventor: Mark Heifets, Kadima (IL)

Correspondence Address: Pearl Cohen Zedek Latzer, LLP, 1500 Broadway, 12th Floor, New York, NY, 10036, US

(21) Appl. No.: 12/376,864

(22) PCT Filed: Aug. 12, 2007
(86) PCT No.: PCT/IL07/01002

§ 371 Date: Feb. 9, 2009

Related U.S. Application Data
(60) Provisional application No. 60/840,386, filed on Aug. 28, 2006.

(51) Int. Cl. G10L 13/08; G06K 9/18; G06F 17/30

(52) U.S. Cl. 704/260; 382/182; 707/769; 707/802; 707/E17.014; 707/E17.044; 704/E13.001

(57) ABSTRACT

System and method for receiving documents of different formats from external sources, analyzing the documents and transforming them into an internal format comprising tokens for effective browsing and referencing, communicating data volumes of transformed documents to a user device, browsing and vocalizing tokens from the documents to the user, receiving and processing verbal user commands pertaining to said vocalized tokens, retrieving documents pertaining to the user command and vocalizing the retrieved documents to said user.

### CROSS-REFERENCE TO RELATED PATENT APPLICATIONS

This patent application claims priority from and is related to U.S. Provisional Patent Application Ser. No. 60/840,386, filed 28 Aug., 2006, this U.S. Provisional Patent Application incorporated by reference in its entirety herein.

### FIELD OF THE INVENTION

The invention relates to the field of text to speech conversion and more specifically to access by verbal commands to selected text items.

### BACKGROUND OF THE INVENTION

The usefulness and convenience of accessing data, of its browsing and the selection of parts therefrom by the use of verbal commands, and the vocalization of the selected data is evident. Under many circumstances, such use of verbal commands may be the only practical or legal way to access data.

Numerous drivers spend long hours commuting between their homes and their places of work, as is often the case in metropolitan areas. This time is wasted and they often look for ways of using it productively. Reading documents on computer screens or manipulating computer keyboards during driving may not be allowed, but listening to audible words is permitted. A majority of these people listen to a car radio or prerecorded audio information during driving. Additionally, unsolicited advertisements often take up a lot of radio broadcasting time, thus diminishing the useful listening time.

Many drivers are interested in daily news and listen to daily newspaper reviews. However, few subscribers are interested in entire periodicals' content (entire daily newspaper, entire e-magazine, all advertisements etc.). An individual is usually interested in certain topics, subjects etc. according to his/her preferences.

Therefore, many commuting drivers would value the possibility to listen to vocalized newspapers' articles selected by them or to parts thereof. Others may prefer to listen to selected vocalized e-mail, to their office documents or to any other written material, and are ready to pay for this service.

In this respect, effective browsing of large volumes of mass media data could help a driver to select interactively the data content rather than switch to another radio broadcasting station and often find, only by chance, a subject of interest.

Different information appliances used by a motorist inside the vehicle, like cellular phones, GPS devices or PDAs, cause the diversion of the motorist's visual attention from the road. The verbal command interface is already used today for controlling some electronic devices inside the vehicle to insure safer driving. However, in spite of the fact that information appliances can be operated by a voice, the data they deliver is aimed to be displayed in a visual form; for example GPS electronic maps or digital broadcasting TV channels adapted for use in vehicle.

It is obvious that delivery or manipulation of large volumes of video information inside a moving vehicle could not be safe for the driver. The safest way to access information of interest by motorists is listening.

It is known that the performance of computer components such as CPU is fast increasing, while their cost decreases. As a result, the computational and other capabilities of small, hand-held devices such as cellular telephones and PDAs fast increase and they can now perform many duties which, until lately, could be performed only by PCs and workstations. It is also known that the cost of wired or wireless communication such as via internet, via cellular telephone or satellite connection decreases fast. The trends of increasing performance and lowering cost are likely to continue in the foreseeable future and continuously affect the economics of communication and the composition of information handling devices.

Of the general purpose information networks, the importance of the global computerized network called “World Wide Web” or the Internet is well known. It permits access to a vast and rapidly increasing number of sites that can be selected by browsing with the aid of a variety of search engines. Such search usually calls for a lengthy visual attention by the user.

Unfortunately, the Internet is also the target of numerous viruses and other kinds of malware, some of which are extremely harmful. Other networks are less prone to this kind of malware, at least due to their more limited scope and, therefore, the more limited opportunities open to the malware creators to play extensive havoc. It might be advantageous to many users, and to the providers of specialized services, to use data communication means other than the Internet.

There is therefore need for such specialized services, namely providing paid access, browsing, selection and vocalization capability of a range of commercial publications such as newspapers, to users. This is true in particular in metropolitan areas, where such users are numerous.

Interactive browsing method implemented in the form of verbal command interface preserves the safety of driving conditions for driver, passengers and pedestrians.

Received data could be vocalized in audio form in full without diverting driver's attention from the road providing him with fairly acceptable method of access to large volumes of information.

Several other groups of people would benefit from such a service.

One such group is of the visually impaired, who might find the ability to use audio commands for the selection of vocalized data extremely helpful or, indeed, the most practical way to access such data.

Many persons with normal eyesight might find this service convenient for home or office use, permitting them to create a useful audio ambiance of their choice.

Another group might be of joggers, bikers, persons spending time in the outdoors and the like who may not want to carry a computer screen, keypad and a mouse with them, but would still like to remain in touch with data of their choice.

### SUMMARY OF THE INVENTION

According to a first aspect of the present invention, there is provided a system comprising a system server and a user device connected with the system server; the server comprising: first communication means for receiving user commands from said user device and for communicating textual information to said user device in response to said received commands; means for processing said user commands; second communication means for communicating with at least one external data source for requesting and receiving documents; means for analyzing documents received via said second communication means, said means for analyzing comprising means for identifying said documents' structure and means for assigning different tokens to different document parts; means for transforming said analyzed documents into an internal digital format comprising said assigned tokens; means for storing said transformed documents; and means for retrieving documents from said server storage, wherein said first communication means is adapted to receive user commands from said user device and to communicate said transformed documents in textual form to said user device; and said user device comprising: storage means for storing said communicated documents; an interactive voice-audio interface comprising means for receiving verbal user commands and means for vocalizing tokens and selected documents; a processor connected with said interactive voice-audio interface, said processor comprising: means for browsing tokens and vocalizing them for user selection; speech recognition means for interpreting user commands; means for retrieving documents according to said user selection from one of said user device storage means and said server storage means; text-to-speech means for transforming said selected documents into audio format; and means for vocalizing said selected documents.

According to a second aspect of the present invention, there is provided a method comprising the steps of: receiving documents of different formats from at least one external source; storing said documents in a database residing on a system server; analyzing said documents; transforming said analyzed documents into an internal format comprising tokens for effective browsing and referencing; creating at least one data volume from said transformed documents; communicating said data volume from said system server to a user device memory; storing said communicated data volumes on said user device; browsing and vocalizing tokens from said stored volume to the user; receiving verbal user commands pertaining to said vocalized tokens; processing said received user command; retrieving documents pertaining to said user command from one of said user device memory and said database; and vocalizing said retrieved documents to said user.

### BRIEF DESCRIPTION OF THE DRAWINGS

FIG. 1 is a scheme showing the main components of the system of the present invention;

FIG. 2 is a block diagram of the system server of the present invention;

FIG. 3 shows three schematic embodiments of the user-device according to embodiments of the present invention;

FIG. 4 is a schematic representation of the data block comprising a table of contents and data volumes according to the present invention;

FIG. 5 is a flowchart representing one embodiment of browsing according to the present invention; and

FIG. 6 is a flowchart representing another embodiment of browsing according to the present invention.

### DETAILED DESCRIPTION OF PREFERRED EMBODIMENTS

The present invention provides an interactive voice-operated access and delivery system to large amounts of selectable textual data by vocalizing the data.

In the following detailed description, numerous specific details are set forth regarding the system and method and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

In the following description, some embodiments of the present invention will be described as software programs. Those skilled in the art will readily recognize that the equivalent of such software can also be constructed in hardware.

Throughout this document, the term “data” refers to any publishable material prepared in computer readable formats in which the material, such as an article, may be interspersed with structural and formatting instructions defining components such as title, sub-title, new paragraph, comment, reference and the like. Such formats are widely used in publications such as newspapers, magazines, office documents, books and the like, as well as in computer readable pictures, graphics files and audio files.

Throughout this document the terms “driver” or “motorist” of a vehicle can be applied also to a visually impaired or immobile, e.g. paralyzed persons. Visually impaired or immobile people face similar difficulties to those faced by drivers attempting to browse while driving.

Throughout this document the term “handling” of data refers to any or all of the following or similar steps or operations: the acquisition, the storage, the browsing, the selection and the vocalization of data.

Throughout this document the term “token” refers to a formatting item designating parts of a document's data as titles, sub-titles, beginning of paragraph, comments and the like.

Throughout this document the term “vocalized” as used herein implies that data tokens along with content data are output vocally via the interactive voice interface so as to allow verbal selection of one or more data items.

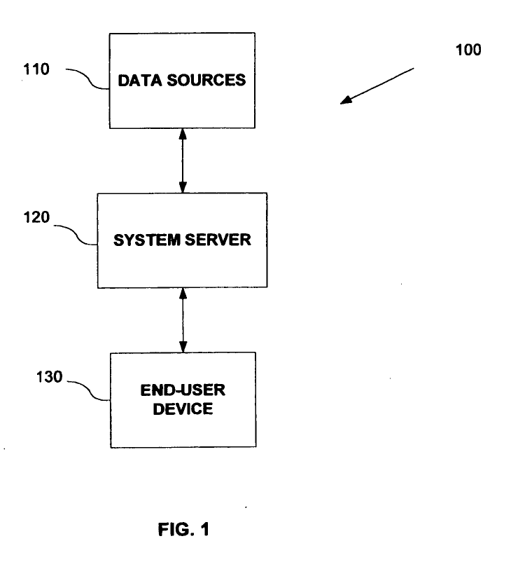

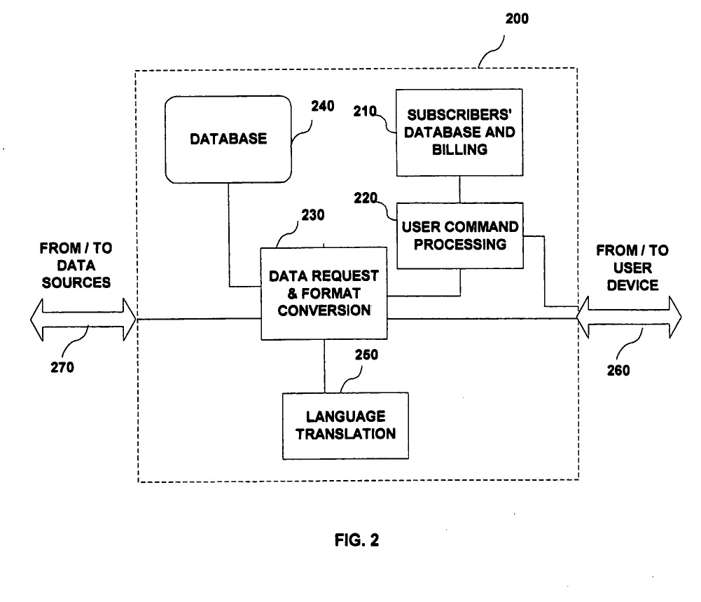

FIG. 1 is a schematic representation showing the main components of the system of the present invention. The system, generally denoted by numeral 100, comprises data sources 110, a proprietary system server 120 and an end-user device 130.

Data sources 110 may include any source holding computer-readable documents. It is known that most of the commercial and office publications are prepared nowadays in computer readable formats with interspersed formatting instructions. Some of the better known data formats are HTML, XML, DOC, PDF and other general or specialized formats. These formats are usually used in the publication of recent and current newspapers, magazines, internet transmitted or transmittable documents and many others and, with all probability, these and similar formats will continue to be used for related purposes in the foreseeable future. It is therefore expected that future formats will also be amenable to handling by the present system. Data files can be created from older, hard copy documents, by using OCR (optical character recognition) techniques.

Among this information a significant amount of data is presented in textual form. Textual content of digital data editions like web newspapers, magazines, articles could be effectively delivered to information consumer in audio form. The same is true for other information sources existing in electronic form like e-mails, digital books (e-books) etc.

Data sources 110 may communicate this computer readable information to system server 120, using any suitable communication means such as but not limited to a wired network such as the internet, intranet or a LAN, or by infra-red transmission, Blue-tooth (“BT” hereinbelow), cellular network, Wi-Fi, WiMAX, or ultra wide band (UWB). The data is then stored in a computer-accessible memory for handling, as will be explained in more detail hereinbelow.

System server 120 may be any computer, such as IBM PC, having communication means, data storage and processing means. System server 120 receives user commands from user device 130 and sends back the requested information, either from its internal storage or from external data sources 110, as will be explained in detail hereinbelow.

End-user device 130 may be an especially designed device, or a PDA, Smartphone, mobile phone or other mobile device having communication means, processing means and an audio interface. End-user device communicates with system server 120 using any suitable communication means such as but not limited to LAN, wireless LAN, Wi-Fi, WiMAX, ultra wideband (UWB), blue tooth (BT), satellite communication channel or cable modem channel.

FIG. 2 is a block diagram showing the different components of the system server, generally denoted by numeral 200, according to embodiments of the present invention:

User command processing module 220 receives user commands via communication channel 260, processes it and passes it on to data request and format conversion module 230. The processing performed by module 220 may comprise, for example, determining whether the present request is within the requester's profile, or whether additional charges should be imposed for this request. Module 220 subsequently informs subscribers' database and billing module 210 of the new transaction.

Subscribers' database and billing module 210 holds a database of subscribers and may charge their accounts for each new transaction.

Data request and format conversion module 230 receives the request from user command processing module 220 and queries database 240 for the existence of the required data item. If negative—module 230 searches the data sources, via communication link 270, for the required items. Module 230 converts newly acquired items into an internal format. The conversion includes parsing and analyzing the document and identifying document parts such as title, abstract, main body, page streaming, advertisements, pictures, references or links, etc. The various parts are identified and marked by respective tokens in the converted document and the tokens are added to a structure residing in database 240, as will be explained in detail below, reflecting the hierarchies in the analyzed volume, e.g. Title, Abstract, etc. Converted documents may also be stored in database 240. Large data volumes may be compressed, either prior to storing or before communicating to the user device, to facilitate effective bandwidth transmission. Pictures and graphic elements may be processed by image analysis software such as described, for example, in Automatic Textual Annotation of Video News Based on Semantic Visual Object Extraction, Nozha Boujemaa, et als, INRIA-IMEDIA Research Group, the article incorporated herein by reference in its entirety. The subjects of the analyzed pictures may be stored for future reference. Music files may be stored in e.g. MP3 format.

Language translation module 250 may optionally translate retrieved documents to the system's preferred language. Language translation by module 250 may be done automatically to a language according to the user's profile, in which case the tokens will be respectively translated to the language of choice.

According to some embodiments, the translated documents are stored textually, in the translated form, in database 240, which permits only one text-to-speech engine to reside on end-user device, according to the user's preferred language.

Database 240 stores text documents in the internal format. Since the database is limited in size for storing documents, various known in the art methods may be used to manage the database contents' limited size, such as compression or cash organized according to frequency of demand. Alternatively and additionally, text documents in internal format may be stored in the user device, as will be explained below or in the system servers' memory.

The server also maintains one or several contexts. It monitors and maintains the state of client activity, such as active channels, playback status (playing, paused, stopped etc. . . . ), content status (read, unread, etc. . . . ). It is also responsible for managing the download/upload of the information to and from the server.

The server is also responsible for parsing source data and templates. The parsed templates are stored in the database 240, one for each website site, each e-library format, each e-book format, e-mail format etc. Documents from data sources related to stored templates will be analyzed accordingly.

According to some embodiments, documents stored in database 240 may be automatically updated. The automatic update scheme may be periodical, e.g. a monthly magazine, or dependent on changes made to the original document.

According to some embodiments, new documents may be automatically acquired by the system server, according to the user profile. For example, new publications related to a topic of interest, whether specifically defined or inferred from past user activity, may be presented to the user.

According to some embodiments, a user profile may comprise an “update notification” field, for notifying the user whenever an update is available for e.g. one or more periodical documents within the range of the subscriber's profile or his scope of interests. The notification may be created as a text message to be delivered to the end user device and can be vocalized for listening by the user at a time according to his preferences, for instance at the end of listening to current content, within the pause just after previous verbal command was issued by him etc.

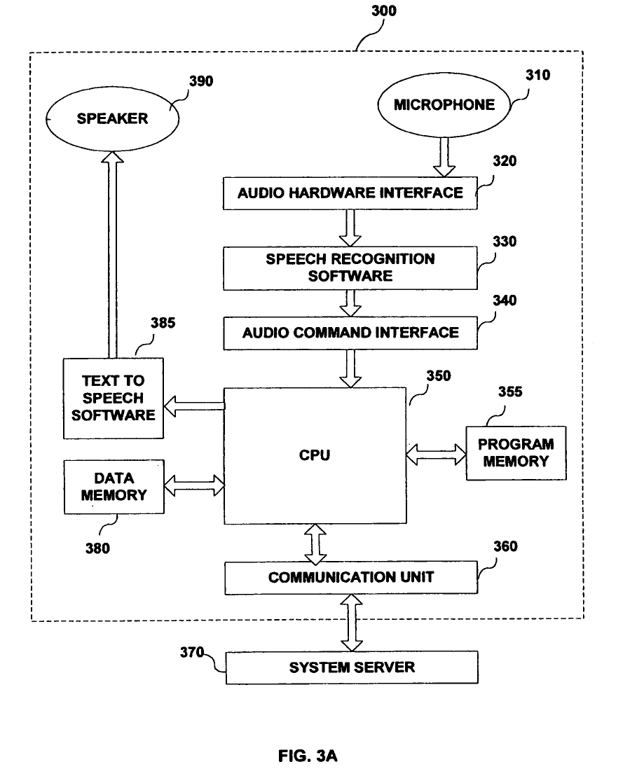

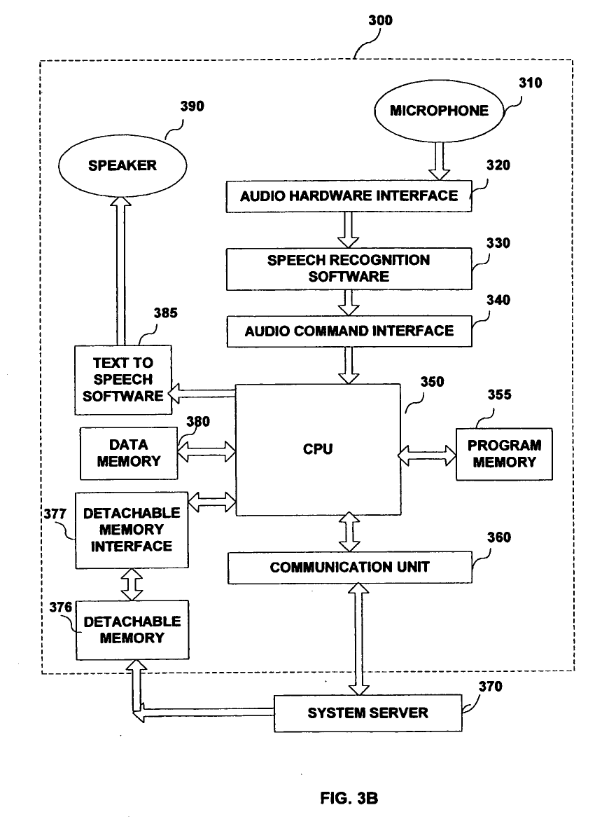

FIGS. 3A through 3C are block diagrams showing different exemplary embodiments of the user device according to the present invention, generally denoted by numeral 300.

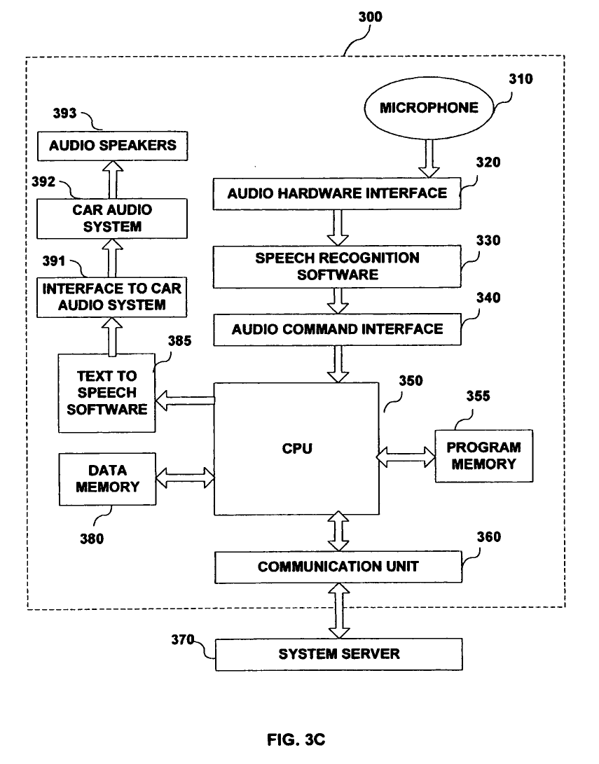

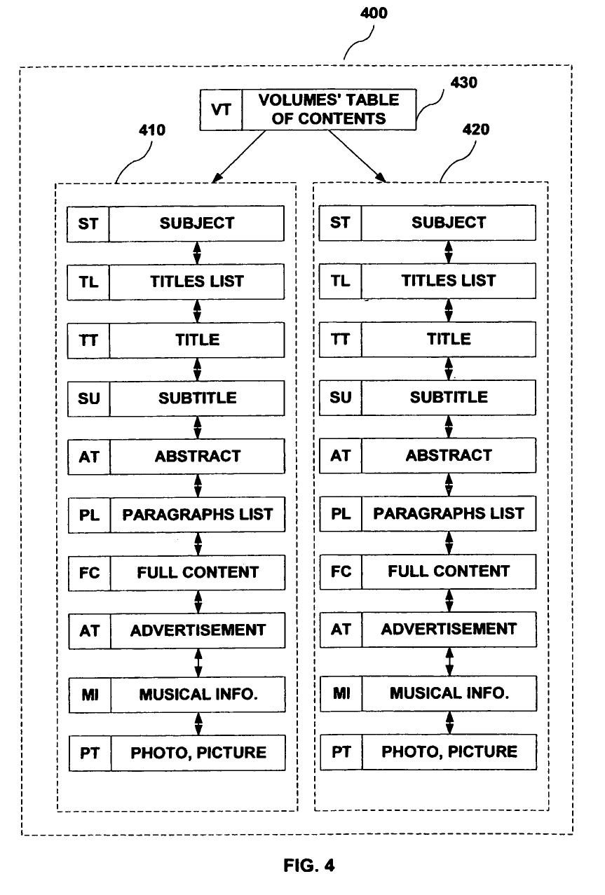

Turning to FIG. 3A, user device 300 comprises a microphone 310, which converts the user's voice sound waves into input analog electrical signals, which are fed into an audio hardware interface 320. Microphone 310 may be, but is not limited to, a mobile phone microphone, or a headset microphone such as Logitech PC120 Headset, preferably communicating wirelessly with interface 320. Audio hardware interface 320, such as AC97 Audio CODEC, digitizes the input analog signals, which are then fed into speech recognition software module 330, comprising speech recognition software such as IBM ViaVoice Desktop Dictation, which converts the digital input signals into synthetic commands to be processed by audio command interface 340. Audio command interface 340 receives the synthetic commands and converts them into commands executable by CPU 350. CPU 350 retrieves the requested data, either from internal data memory 380, or, through communication unit 360, from the system server 370. The detailed manner of retrieving data will be explained in detail below, in conjunction with FIGS. 4 through 6.

The set of commands provided to the audio command interface 340 may by a restricted set of verbal commands (lexicon) in order to provide a reliable and effective voice user interface (VUI). Use of the restricted set of verbal commands is possible in conjunction with structured menus presented vocally to the user. It allows the driver to remember a small number of verbal commands and answer the system menu inquiries by mono-syllable vocals such as “yes” or “no”, “one”, “two”, “three” etc.

According to some embodiments, the set of verbal commands may include broadcasting type commands aimed for other system subscribers' information. Such commands may be given by an authorized user, for example after listening to the last retrieved document, for sending it through the system to other subscribers, e.g. for the approval of an enterprise's announcement, advertisement approval etc.

The retrieved data items are vocalized by text-to-speech software 385, to create high-level synthesized speech. The text-to-speech software 385 may include grammar analysis, accentuation, phrasing, intonation and duration control processing. The resulting sound has a high quality and is easy to listen to for long periods. Exemplary commercially available text-to-speech software applications are Accapela Mobility TTS, by Accapela group and Cepstral TTS Swift, by Cepstral LLC. The vocalized components are input to user's audio interface 320, which directs them to the user's speakers 390.

According to some embodiments, text-to-speech software 385 may reside on the system server, whereby the information in audio streaming form is delivered through the communication channel to the end user device for listening in real time. The information thus converted to audio form, includes tokens as well as data content.

FIG. 3B shows an alternative non-limiting embodiment of the user device 300. According to this embodiment user device 300 comprises one or more detachable memory device 376. The detachable memory device may be selected from numerous available commercial devices such as, but not limited to flash memory devices, CD ROMs and optical disks. New detachable memory devices may be developed in the future, that could be used without loss of generality of the invention. The data may be copied onto the detachable memory device from a personal computer or from the system server 370. The data from the detachable memory device 376 is read by CPU 350 via detachable memory interface 377, such as USB and stored in data memory 380.

According to some embodiments, the user may be provided with a server application comprising all the analyzing, browsing and vocalizing functionality described above. According to this embodiment, the user may store his documents in advance, on a processing device capable of attaching to the car such as a PDA, and use the server application to analyze the documents and create the structured document as described above, in the internal format. When attached to the car, the system may be operated locally to retrieve and vocalize documents.

FIG. 3C shows another non-limiting embodiment of the user device 300. According to this embodiment the special speaker 390 is replaced by the general purpose car audio system. The vocalized text from text-to-speech software 385 is fed to the car audio system 392 through interface 391 and vocalized through audio speakers 393.

According to some embodiments, a built-in device in the car, such as a PDA comprising a GPS navigation system, may be used to communicate wirelessly with the car's audio systems; a headset microphone may communicate the user's commands to the device using Bluetooth communication and the vocalized output may be transmitted by the device to the car's stereo system using an extra FM frequency.

According to some embodiments, a detachable memory device such as, for example, a disk-on-key, which may be connected via USB to a built-in or detachable processing device, may store the processed documents.

In all the embodiments of the user device 300, the microphone and speakers are proximate to the end user, so that the user's verbal commands may advantageously be intercepted by the system and the system's vocal responses may be heard by the user. Further enhancement of the audio command reliability may be achieved by using techniques such as visual command duplication on one-line LCD or vocalizing of the received command via playback. Visual display of the verbal commands given by the user may be additionally used to enhance the end-user device control in noisy audio environments.

Interfaces to user's microphone and/or speakers may be wired, FM, Bluetooth, or any other suitable communications interface. Speakers and/or microphone may also be installed in a headset worn by the user.

According to certain embodiments, some of the components described above as residing in the user device 300, may be incorporated in an end-user proximate unit, such as headset. For example, any one or group of units 390, 320, 330, 340, 350, 360, 380, 385 and 355 may reside on a user-proximate unit with only wired communication between them. Alternatively, the user-proximate device may incorporate only units 320, 330, 340, 350, 380 and 355, using a cellular phone as a communications unit.

Not limited by these examples, a communication unit may use LAN, Wi-Fi, WiMAX, ultra wideband (UWB), Bluetooth (BT), satellite communication, cable modem channel, and more.

PDA, Smartphone, mobile phone or other handheld devices may serve as end-user device 300, in which case the car cradle attachment may be used to support and electrically feed the end-user proximate device or any of its parts.

FIG. 4 shows a schematic representation of the system's data block 400 according to some embodiments of the present invention. Data block may be stored in the data memory 380 of user-device 300. Alternatively, data block 400 may be stored on a user-proximate device, as described above, or on the system server.

Data block 400 contains the table of contents 430 and the data volumes referenced by the table of contents (only two exemplary ones are shown, 410 and 420). A volume may represent a variety of entities, such as but not limited to: a magazine, a newspaper, a book, an e-mail folder or folders, a business folder or folders, or a personal folder comprising various documents belonging to a user.

Each volume comprises selected items, such as Subject, Titles List, etc. and respective tokens ST, TL etc.

All or part of the table of contents 430 may be presented to the user as a menu for selecting items of interest.

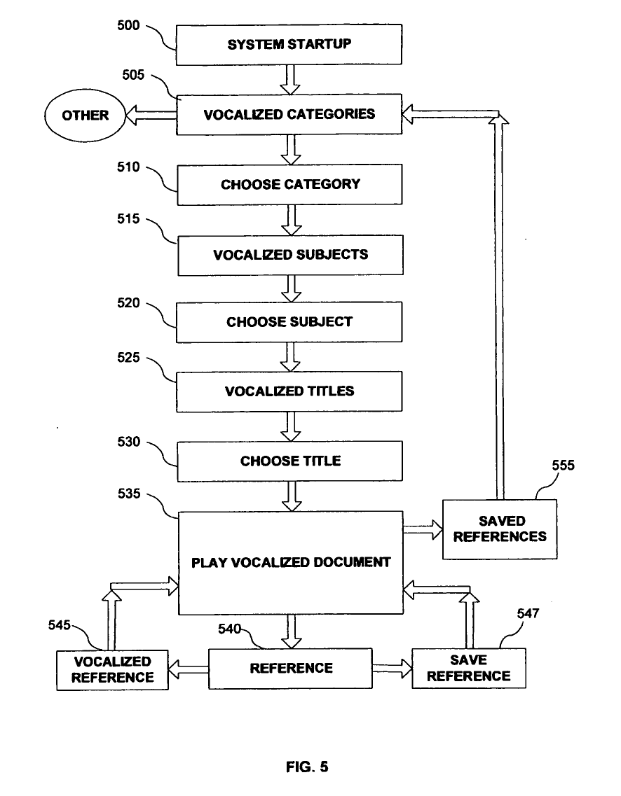

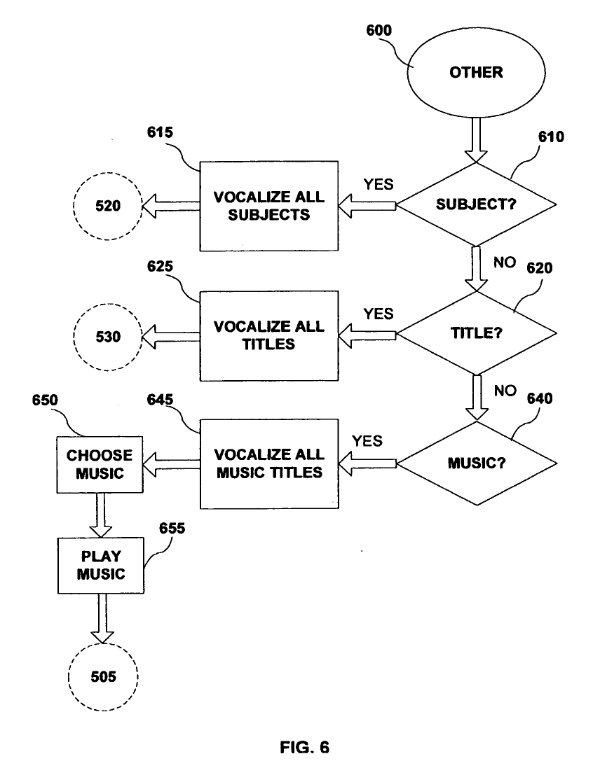

The table of contents may be browsed vertically by selecting a volume and browsing it serially. Alternatively, the table of contents may be browsed horizontally, by selecting a token. In yet another embodiment, a keyword search may be conducted on the entire contents of the volume. The various browsing modes will be explained in detail below in conjunction with FIGS. 5 and 6.

FIG. 5 is a flowchart describing an exemplary non-limiting workflow according to the present invention, showing a vertical browsing scenario. After system startup (step 500) the system accesses the table of contents 430, creates a menu from at least part of the items in the table of contents and vocalizes the categories in the menu (step 505). For example, the user may hear phrases like “e-mail inbox”, “USA today”, “personal folder”, “books”, “magazines”, etc. Each vocalized item may be preceded or followed by an ID label, such as its ordinal number in the vocalized list. At any moment during the vocalized list, or at its end, the user may select a volume (or category) by pronouncing the respective ID label (step 510), which may be easier to remember than the token it denotes. Alternatively, the user may pronounce a command such as “other”, or explicitly pronounce a keyword such as “subject”, “title” etc., thus initiating a horizontal browsing, as will be explained in detail in conjunction with FIG. 6. If a category has been selected, the system proceeds to vocalize all the subjects in the selected category (step 515), along with ID labels and the user may choose a subject (step 520). After a subject has been selected, the system proceeds to vocalize all the titles in the selected subject, along with ID labels (step 525) and the user may select a title by vocalizing its respective ID label (step 530). It will be understood that the vertical browsing described above may continue, depending on the number and types of items in each volume, to include subtitles, abstracts and paragraphs' lists, with the final aim of identifying a single document or part of a document required by the user.

Once the requested document has been identified, the system proceeds to fetch the document from the device internal memory, from system server 370, through communication unit 360 or from a detachable memory device 376. The document residing on system server 370 or detachable memory device 376 has already been processed and converted into the system's internal format, including tokens to denote its various parts. The information volume may have been preliminarily downloaded to the detachable memory device in another network communication session. For example (but not limited to) it may have been downloaded from the system server while the memory device was connected to a wired net LAN personal computer.

The system may now use text-to-speech module 385 to vocalize the fetched document and play it to the user (step 535).

According to some embodiments, the menu parameters may be automatically changed according to driving conditions, e.g. in case of stressed road condition. Driving conditions parameters can be indirectly or directly supplied to the end-user device's CPU from different vehicle subsystems such as speedometer, accelerometer etc., or from various additional physiological sensors (driver's head movement, driver's eyes movement etc). Menu parameters may also be changed by the user according to his decision. The changes may include a decrease in the length of menus presented to the user without pause, change in the menu's inquiry structure, for instance asking for user's simple answer after each vocalized menu item like “yes” or “no” etc.

A similar approach may be provided for the parameters of text-to-speech vocalizing during changing in driving conditions or operating environment. In this case the retrieving pace of the text-to-speech module may be controlled, as well as pauses' duration, etc.

In the course of vocalizing a document, items such as advertisements, pictures or references (links) may be encountered and identified by their respective tokens. These items, which do not comprise part of the streamed text, will be vocally presented to the user in a manner depending on their type. For example, a picture may be presented by the word “picture” followed by its vocalized subject and a reference may be presented by the word “reference” followed by its vocalized text. If a reference is presented (step 540), the system may wait for the user's indication whether to exercise the reference instantly (step 545), in which case a new user request is created and the document pointed to by the reference is being fetched, or the user may indicate that he does not wish to hear the referenced document at the present time, in which case the reference will be saved for later use (step 547) and the main document's vocalization will continue. In the case where a reference was chosen to be exercised immediately, the system will save the interrupted document, along with a pointer to the reference, and the document's vocalization will resume once the reference document has been vocalized.

Once a current document's vocalization has terminated, the system may present the user with a vocalization of the saved references to choose from (step 555).

According to some embodiments, upon system startup the user is not automatically presented with a list of categories, rather the system waits for user commands. If the user pronounces “categories”, the system will proceed as described above in conjunction with FIG. 5, to vocalize the stored categories. However, the user may pronounce a different command, denoting a lower-order entity such as “subject”, “title” etc.

Attention is drawn now to FIG. 6, showing a flowchart of the system's operation according to another exemplary, non-limiting embodiment. The embodiment of FIG. 6 shows horizontal browsing of the table of contents 430, as may be initiated after the system's automatic vocalization of categories, or as a first user command after system startup.

If, for example, the user command was “subject” (step 610), the system proceeds to horizontally extract all the entities having a “subject” token (ST) from all the available volumes in the data block 400. As described above in conjunction with FIG. 5, the subjects will be vocalized, accompanied by ID labels. The system then proceeds to step 520, allowing the user to choose a subject from the vocalized list. The browsing will proceed vertically as in FIG. 5.

If the user command was “title” (step 620), the system proceeds to horizontally extract all the entities having a “title” token (TT) from all the available volumes in the data block 400. As described above in conjunction with FIG. 5, the titles will be vocalized, accompanied by ID labels. The system then proceeds to step 530, allowing the user to choose a title from the vocalized list.

It will be understood that additional user commands may be allowed, depending on the number and types of items in the system, such as subtitles, abstracts and paragraphs' lists.

In some embodiments where use of a limited set of verbal commands is preferable, for instance during driving, where it is required to provide a simple and noise-immune vocal user interface (VUI), context sensitive commands may be provided, so that the meaning of each command from said restricted plurality of verbal lexicon depends on the type delivered vocalized content. For example, when listening to an e-mails list, the command “next” and “previous” could mean a pass to a next (previous) e-mail message, or while listening to a magazine's article the same commands can mean pass to the next (previous) paragraph. An associated computer subroutine running on the server or/and on the client implements these semantic change switching.

If the user command was “music” (step 640), the system proceeds to horizontally extract all the entities having a “music” token (MI) from all the available volumes in the data block 400. As described above in conjunction with FIG. 5, the music titles will be vocalized, accompanied by ID labels. The user may choose a music file (step 650) and the file will be played (step 655).

According to some embodiments, music files may be communicated to the end user device in audio stream format.

Similarly, the user command may be “picture” or “advertisement” or any other entity represented by a token in the table of contents, whereby appropriate items will be fetched using a horizontal search of the volumes. Pictures will be presented by vocalizing their subject, as described above.

According to some embodiments, the user command, e.g. “subject”, may be followed by a specific name (e.g. subject name), in which case the system will perform a horizontal search for the specified name, without the need to vocalize all the relevant items.

According to some embodiments, user commands may additionally comprise commands such as “stop”, “pause”, “forward”, “fast forward”, “rewind”, “fast rewind” etc.

According to some embodiments, new user commands may be interactively added to the system. For example, while listening to a vocalized document the user may hear a word he would like to change into a keyword, in order to receive additional documents pertaining to that word. The user may issue a “stop” command as early as possible after having heard the word and then use the “rewind” and “forward” commands to pinpoint the exact word. The user may then issue an “add keyword” command targeted at the pinpointed word, which will then be treated as a keyword, as explained in conjunction with FIG. 5. The new keyword may be stored in the user device or on the system server, as either a private or a general new token.

According to some embodiments the user may memorize audio message for subsequent use in the end user device. The vocal message memorizing will follow some lexicon command, for instance “write”. It will be memorized as an audio file in the end user device memory and retrieved as a stream audio data by the end user device in a predetermined time. This memorized message can be sent to the system server by another command, with the appropriate token designating its audio type. Such feature will be useful for a number of applications, including blog messages creation, diary notes preparation etc.

According to some embodiments, if a new keyword defined by the user does not yield any documents, i.e. the new keyword does not exist in the volume, the system may respond by initiating a keyword search in the server database 240, and, if necessary, in outside data sources connected to the server such as the Internet, or any other data source as described above.

According to some embodiments, multiple search sessions may be initiated simultaneously by the user, by using verbal commands or keywords as described above. The multiple sessions' search results may be presented to the requester vocally and sequentially, accompanied by ID labels, to be chosen for vocalizing. The user may circularly switch between the various documents by using a “Tab” command.

According to some embodiments, the user may use a “Pause” command to pause in the middle of a vocalized session. For example, the user may have been listening to a vocalized document and has now arrived home. A “Resume” command will enable the user to resume the interrupted session at a future time. Alternatively, the user of the previous example may use his home computer to access the interrupted session on the system's website, visually.

According to some embodiments, the system's website may allow user access to previous audio or visual sessions' log-files, references, commands, keywords and any other information pertaining to the user's activities, such as billing and/or profile information.

According to some embodiments, the user may initiate new documents' retrieval using the system's website.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A system comprising:
a system server; and
a user device connected with said system server;
said server comprising:
first communication means for receiving user commands from said user device and for communicating textual information to said user device in response to said received commands;
means for processing said user commands;
second communication means for communicating with at least one external data source for requesting and receiving documents;
means for analyzing documents received via said second communication means, said means for analyzing comprising means for identifying said documents' structure and means for assigning different tokens to different document parts;
means for transforming said analyzed documents into an internal digital format comprising said assigned tokens;
means for storing said transformed documents; and
means for retrieving documents from said server storage; and
said user device comprising:
storage means for storing said communicated documents;
an interactive voice-audio interface comprising means for receiving verbal user commands and means for vocalizing tokens and selected documents;
a processor connected with said interactive voice-audio interface, said processor comprising:
means for browsing tokens and vocalizing them for user selection;
speech recognition means for interpreting user commands;
means for retrieving documents according to said user selection from one of said user device storage means and said server storage means;
text-to-speech means for transforming said selected documents into audio format; and
means for vocalizing said selected documents.

2-9. (canceled)

10. The system of claim 1, wherein said user device additionally comprises means for one of user command audio playback and visual duplication of user commands.

11. (canceled)

12. The system of claim 1, wherein said at least one external data source comprises providers of at least a website, an e-mail server, digital advertisements, digital newspapers, digital magazines, digital books, intranet and e-libraries.

13-14. (canceled)

15. The system of claim 1, additionally comprising means for automatically retrieving documents from said external sources according to one of user profile and user history.

16. The system of claim 1, wherein said means for processing user commands comprise means for comparing said user command with said user profile.

17-22. (canceled)

23. The system of claim 1, wherein said means for receiving verbal user commands comprise means for receiving at least one of ID token label, predefined command word and keyword.

24. The system of claim 23, wherein said predefined command word comprise a command for memorizing a message.

25. The system of claim 23, wherein said means for receiving a keyword comprise means for identifying keywords in a vocalized document stream.

26. (canceled)

27. The system of claim 25, additionally comprising means for storing said identified keywords on one of said user devices or system server.

28-29. (canceled)

30. The system of claim 1, additionally comprising a website.

31. The system of claim 30, additionally comprising means for pausing the vocalization of documents and visually resuming said paused document on said website.

32-38. (canceled)

39. The system of claim 1, wherein said vocalized documents comprise vocalized references to other documents.

40. The system of claim 39, additionally comprising means for storing said references for future use and means for browsing said references.

41. (canceled)

42. The system of claim 1, additionally comprising means for adapting at least one of said vocalizing tokens and said vocalizing documents to driving conditions.

43. The system of claim 42, wherein said means for adapting to driving conditions comprise at least one of means for sensing vehicle's parameters and means for sensing driver's condition.

44. The system of claim 42, wherein said means for adapting to driving conditions comprise means for presenting a choice to the driver.

45. The system of claim 1, additionally comprising means for simultaneously initiating a plurality of search sessions.

46. The system of claim 45, additionally comprising means for switching between vocalized documents resulting from said plurality of search sessions.

47-49. (canceled)

50. The system of claim 1, wherein said means for analyzing documents comprise templates means for parsing according to the format of the respective data source.

51-53. (canceled)

54. The system of claim 1, wherein said verbal user commands comprise a broadcasting command.

55. A method comprising the steps of:
receiving documents of different formats from at least one external source;
storing said documents in a database residing on a system server;
analyzing said documents;
transforming said analyzed documents into an internal format comprising tokens for effective browsing and referencing;
creating at least one data volume from said transformed documents;
communicating said data volume from said system server to a user device memory;
storing said communicated data volumes on said user device;
browsing and vocalizing tokens from said stored volume to the user;
receiving verbal user commands pertaining to said vocalized tokens;
processing said received user command;
retrieving documents pertaining to said user command from one of said user device memory and said database; and
vocalizing said retrieved documents to said user.

56-106. (canceled)

107. A computer-readable medium having computer-executable instructions stored thereon which, when executed by a computer, will cause the computer to perform the method of claim 55.
